(19) United States
(12) Patent Application Publication
(10) Pub. No.: US 2013/0148852 A1
(43) Pub. Date: Jun. 13, 2013

(54) METHOD, APPARATUS AND SYSTEM FOR TRACKING AN OBJECT IN A SEQUENCE OF IMAGES

(71) Applicant: CANON KABUSHIKI KAISHA, Tokyo (JP)

(72) Inventors: ASHLEY JOHN PARTIS, New South Wales (AU); DAVID GRANT MCLEISH, New South Wales (AU); PETER JAN PAKULSKI, New South Wales (AU)

(73) Assignee: CANON KABUSHIKI KAISHA, Tokyo (JP)

(21) Appl. No.: 13/706,232

(22) Filed: Dec. 5, 2012

(30) Foreign Application Priority Data
Dec. 8, 2011 (AU) 2011253910

(51) Int. Cl. G06K 9/62

(52) U.S. Cl. CPC G06K 9/6201
USPC 382/103; 382/209

(57) ABSTRACT

A method of tracking an object (e.g., 1110) in a sequence of images of a scene, is disclosed. At least one foreground area in the scene is associated with the object (1110). An event that is affecting the foreground area of the scene is determined A track representation is added to a track corresponding to the object (1110). The added track representation models the determined event and has a property based on the foreground area. Properties of one or more further track representations of are track updated, based on the foreground area, in order to track the object (1110).

### REFERENCE TO RELATED PATENT APPLICATION(S)

This application claims the benefit under 35 U.S.C. §119 of the filing date of Australian Patent Application No. 2011253910, filed 8 Dec. 2011, hereby incorporated by reference in its entirety as if fully set forth herein.

### FIELD OF INVENTION

The current invention relates to the tracking of objects in a sequence of images and, in particular, to a method and apparatus for tracking an object in the sequence of images. The current invention also relates to a computer program product including a computer readable medium having recorded thereon a computer program for tracking an object in a sequence of images.

### BACKGROUND

Surveillance cameras, such as Pan-Tilt-Zoom (PTZ) network video cameras, are omnipresent nowadays. The cameras capture more data (video content) than human viewers can process. Automatic analysis of the captured video content is therefore needed.

An important part of automatic analysis of video content is the tracking of objects in a sequence of images captured of a scene. Objects may be separated from a background of the scene and treated as foreground objects by a previous extraction process, such as foreground/background separation. The terms foreground objects, and foreground, usually refer to moving objects, e.g. people in a scene. Remaining parts of the scene are considered to be background.

Foreground/background separation allows for analysis, such as detection of specific foreground objects, or tracking of moving objects within a sequence of images. Such further analysis has many applications, including, for example, automated video surveillance and statistics gathering, such as people counting.

One method of foreground/background separation is statistical scene modelling. In one example, a number of Gaussian distributions are maintained for each pixel of an image to model the recent history of the pixel. When a new input image of a sequence of images is received, each pixel from the image is evaluated against the Gaussian distributions maintained by the model at the corresponding pixel location. If the input pixel matches one of the Gaussian distributions, then the parameters of the associated Gaussian distribution are updated with an adaptive learning rate. Otherwise, a new Gaussian model for the pixel is created.

Another method of foreground/background separation maintains two pixel-based background models, B1 and B2. B1 contains the minimum value for each pixel location during the initialisation period and B2 contains the maximum value. When a new image is received, the difference between the new image and each of the background models is determined on a per-pixel basis. For each pixel, the corresponding model with the smallest difference for that pixel is updated using an approximated median update method with a fixed learning rate.

Another method of foreground/background separation uses a double background model that is able to handle both rapid and gradual changes of the scene. In order to do that, a normal background model is derived from a list of cached frames that were sampled at a constant rate. The double background model system also tries to detect a large change condition in the scene. Only once a large change condition is detected is a new background model created, based on another list of cached frames that were sampled at a faster rate than the normal background model.

Foreground/background separation typically detects foreground areas of a scene as blobs, where each blob represents a foreground area of a scene. Blobs have no consistent identity within each subsequent image of an image sequence without a later step, such as a tracker, to resolve the identities of blobs over time.

Video object tracking provides a consistency across images of an image sequence for foreground areas by associating blobs with each other across multiple images (i.e. over time).

The process of foreground/background separation to produce foreground areas, also called detections, can introduce errors as measurement of object locations and object characteristics may be inaccurate. Each blob may correspond with one or more objects. However, the relationship of a blob, or multiple blobs, to an object may be unclear. For example, one object may correspond to multiple foreground areas, or height and width of a foreground area may be smaller than actual width of a corresponding object.

Errors in a foreground/background separation process can include, but are not limited to: detection failure, partial detection failure, multiple foreground areas in place of one, one foreground area in place of multiple foreground areas, over-detection, and entirely false detections. These errors can occur simultaneously within a single frame of an image sequence.

Partial detection failures or failure to detect an object at all can be the result of occlusion by objects that have been classified as background, referred to herein after as “background objects”, or “background clutter”, in the scene. As an object navigates through the scene, the object may be partially or wholly occluded by other items or objects in the scene considered to be background (e.g. a pillar, a desk, a pot plant). As above, the items or objects that are classified as background may be referred to as “background clutter”. As the object passes behind the background clutter, a foreground area or foreground areas detected by a foreground/background separation process that corresponds to the object will have a location, height and width. The location, height and width of the foreground area(s) will have various amounts of error when compared to the location, height and width of the corresponding object. The error results in a mismatch between corresponding tracks and foreground areas as the object enters, passes, and/or leaves the background occluding the object. The error often results in the original track corresponding to the object being lost and a new track being created. Such behaviour is undesirable in video analytics.

A conventional method of tracking an object uses a mean shift algorithm and colour distribution of the object being tracked to find the object within the scene by visual appearance of the object. The conventional method adds robustness where the object being tracked is partially occluded by one or more background objects (“background clutter”). In accordance with the conventional method, error from detected foreground areas is counteracted by data indicating “real” location and composition of the object being tracked, as opposed to using geometry of the foreground areas only. A Kalman filter may also be used for predicting the location of the track in order to reduce search space. However, such iterative visual methods are computationally expensive when compared to a “geometric” tracker which uses foreground area shapes and positions only. Such visual methods can be too computationally demanding to implement on a low-power device such as a video camera.

Other conventional geometric tracking methods, such as a multi-hypothesis tracker, may be robust to occlusions of an object by background objects (“background clutter”) in certain situations by using multiple guesses. However, on an embedded device, such as a video camera, such methods may be too computationally expensive for tracking in real time. Further, geometric tracking methods that are less computationally expensive, such as methods utilising a Kalman filter only, are not robust.

Thus, a need exists to provide an improved method, apparatus and system for tracking an object in a sequence of images that is both robust to occlusions of the object being tracked by one or more background objects (“background clutter”) and that is relatively computationally inexpensive.

### SUMMARY

It is an object of the present invention to substantially overcome, or at least ameliorate, one or more disadvantages of existing arrangements.

The present disclosure relates to a method, apparatus and system for real-time geometric tracking of foreground objects that is robust to occlusions of the foreground objects by one or more background objects.

According to one aspect of the present disclosure there is provided a method of tracking an object in a sequence of images of a scene, said method comprising:
determining an event that is affecting a foreground area corresponding to the object, the object being associated with a track having a first track representation;
adding a second track representation to the track, said second track representation being created based on the foreground area prior to the event;
updating the first track representation based on the foreground area while the second track representation is kept; and
matching at least one of the foreground areas with at least one of the first and second track representations to track the object.

According to another aspect of the present disclosure there is provided an apparatus for tracking an object in a sequence of images of a scene, said apparatus comprising:
means for determining an event that is affecting the foreground area corresponding to the object, the object being associated with a track having a first track representation;
means for adding a second track representation to the track , said second track representation being created based on the foreground area of the object prior to the event; and
means for updating the first track representation, based on the foreground area of the object while the second track representation is kept; and
means for matching at least one of the foreground areas with at least one of the first and second track representations to track the object.

According to still another aspect of the present disclosure there is provided a non-transitory computer readable medium having a computer program stored there for tracking an object in a sequence of images of a scene, said program comprising:
code for determining an event that is affecting a foreground area corresponding to the object, the object being associated with a track having a first track representation;
code for adding a second track representation to the track, said second track representation being created based on the foreground area prior to the event;
code for updating the first track representation based on the foreground area while the second track representation is kept; and
code for matching at least one of the foreground areas with at least one of the first and second track representations to track the object.

According to still another aspect of the present disclosure there is provided a method of detecting occlusion of an object within a captured image of a scene, said method comprising:
determining a first difference between an edge of a prediction of a track corresponding to the object and the corresponding edge of a foreground area of the scene associated with the track;
determining a second difference between a further edge of the prediction of the track corresponding to the object and the corresponding further edge of the foreground area of the scene associated with the track; and
detecting an occlusion of the object if the first difference is less than a first threshold and the second difference is greater than a second threshold.

According to still another aspect of the present disclosure there is provided an apparatus for detecting occlusion of an object within a captured image of a scene, said apparatus comprising:
means for determining a first difference between an edge of a prediction of a track corresponding to the object and the corresponding edge of a foreground area of the scene associated with the track;
means for determining a second difference between a further edge of the prediction of the track corresponding to the object and the corresponding further edge of the foreground area of the scene associated with the track; and
means for detecting an occlusion of the object if the first difference is less than a first threshold and the second difference is greater than a second threshold.

According to still another aspect of the present disclosure there is provided non-transitory computer readable medium having a computer program stored thereon for detecting occlusion of an object within a captured image of a scene, said program comprising:
code for determining a first difference between an edge of a prediction of a track corresponding to the object and the corresponding edge of a foreground area of the scene associated with the track;
code for determining a second difference between a further edge of the prediction of the track corresponding to the object and the corresponding further edge of the foreground area of the scene associated with the track; and
code for detecting an occlusion of the object if the first difference is less than a first threshold and the second difference is greater than a second threshold.

Other aspects of the invention are also disclosed.

### BRIEF DESCRIPTION OF THE DRAWINGS

One or more embodiments of the invention will now be described with reference to the following drawings, in which:

FIGS. 1A and 1B are a schematic block diagram of a camera, upon which methods described below, may be practiced;

FIG. 2 is a flow diagram showing a method of tracking an object in an input image of a sequence of images captured on the camera of FIGS. 1A and 1B;

FIG. 3 is a schematic block diagram showing an example of track representations of a single track;

FIG. 4 is a schematic flow diagram showing a geometric method of tracking foreground areas (“detections”) as used in the method of FIG. 2;

FIG. 5 is a schematic flow diagram showing a method of associating foreground areas with tracks as used in the method of FIG. 4;

FIG. 6 is a schematic flow diagram showing a method of generating association hypotheses for a track representation as used in the method of FIG. 5;

FIG. 7 is a schematic flow diagram showing a method of updating each track representation of a track, as used in the method of FIG. 4;

FIG. 8 is a schematic flow diagram showing a method of updating a track as used in the method of FIG. 7;

FIG. 9 is a schematic flow diagram showing a method of detecting occlusion of an object by one or more background objects (“background clutter”) within a captured image of a scene;

FIG. 10 is a schematic flow diagram showing another method of detecting occlusion of an object by one or more background objects (“background clutter”)within a captured image of a scene;

FIGS. 11A to 11E show an example of background occlusion of a foreground object, with a person passing behind a lamp post;

FIGS. 12A to 12E show a prior art tracker failing to correctly track the person from FIG. 11 passing behind the lamp post; and

FIGS. 13A to 13E show the person from FIG. 11 being tracked in accordance with the method of FIG. 2.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

A video is a sequence of images or frames. Each frame is an image in an image sequence (video sequence). Each frame of the video has an x axis and a y axis. A scene is the information contained in a frame and may include, for example, foreground objects, background objects, or a combination thereof.

A scene model is stored information relating to a scene and may include foreground information, background information, or a combination thereof. A scene model generally relates to background information derived from an image sequence.

A video may be encoded and compressed. Such encoding and compression may be performed intra-frame, such as motion-JPEG (M-JPEG), or inter-frame, such as specified in the H.264 standard.

The present disclosure relates to methods of real-time geometric tracking of foreground objects in an image captured of a scene. The described methods are robust to occlusions of the foreground objects by one or more background objects (“background clutter”).

An image is made up of visual elements. The visual elements may be, for example, pixels, or 8×8 DCT (Discrete Cosine Transform) blocks as used in JPEG images in a motion-JPEG stream, or wavelet domain transformed images as used in JPEG2000 images in a motion-JPEG2000 stream. A visual element position in the frame axis is represented by x and y coordinates of the visual element under consideration.

One representation of a visual element is a pixel visual element. Each visual element may have three (3) values describing the visual element. In one example, the three values are Red, Green and Blue colour values (RGB values). The values representing characteristics of the visual element are termed as visual element attributes. The number and type of values associated with each visual element (visual element attributes) depend on the format utilised for an apparatus implementing methods described below. It is to be noted that values stored in other colour spaces, such as the four-valued Cyan, Magenta, Yellow, and Key black (CMYK), or values representing Hue-Saturation-Lightness, may equally be utilised, depending on the particular implementation, without departing from the spirit and scope of the present disclosure.

Another representation of a visual element uses 8×8 DCT blocks as visual elements. The visual element attributes for an 8×8 DCT block are sixty-four (64) luminance DCT coefficients, sixty-four (64) chrominance red (Cr) DCT coefficients, and sixty-four (64) chrominance blue (Cb) DCT coefficients of the block. The sixty-four (64) luminance DCT coefficients can be further divided into one (1) DC coefficient, and sixty-three (63) AC coefficients. The DC coefficient is a representation of average luminance value of the visual element and the AC coefficients represent the frequency domain information of the luminance characteristics of the 8×8 block. The AC coefficients are commonly ordered from lowest-frequency to highest-frequency components, organised in a zig-zag fashion. AC1 represents the DCT component with the lowest horizontal frequency. AC2 represents the horizontal component with the lowest vertical frequency, and so on. The higher-numbered AC coefficients correspond to higher frequencies. The attributes are represented as (Y, U, V, AC), representing the DC coefficient (Y), the chrominance values (U, V) and the AC coefficients (AC), giving one hundred and ninety six (196) attributes in total. Many other combinations of attributes are possible or other attributes can be generated from the above mentioned attributes using machine learning algorithms, such as linear regression techniques.

The described methods may equally be practised using other representations of visual elements. For example, the DCT blocks may be of a different size to enable a different granularity for storing the attributes of the pixels represented by the DCT blocks. Other transforms, such as wavelet transforms, may also be used to generate representative attributes from the pixels within a scene so that a historical representation of the scene may be accumulated.

As described below, a track is maintained for each object within a sequence of images. Each track is information about tracking for each object. Each track that is maintained has a set of track representations. Each track representation maintains a geometric model of the track, including height, width, and location of a centre point of a bounding box corresponding to the track. The centroid of the track may be maintained instead of the centre point of the track bounding box. Each track representation in a set of track representations also maintains an estimate of the velocity of the track. Each track representation may also maintain a visual signature for the track, such as luminance and chrominance histograms.

The set of track representations contains at least one track representation, referred to as a “normal” track representation. The normal track representation models the track as if a corresponding object is moving through the scene consistently, unoccluded by either background objects (“background clutter”) or other objects, and with no errors affecting detection.

Each track representation is updated in a manner that reflects the reason for creating the track representation. For example, the normal track representation may be updated in a simple manner according to width, height and location of matched foreground areas. In contrast, the track representation that models a hypothesis that the track may be occluded by background objects (“background clutter”), also known as the “occlusion” track representation, is updated as if the track is passing behind one or more background objects. In this instance, the track maintains a consistent height and width, and actual location of the track may be estimated using edges of the track that are not occluded.

The methods described below detect when an occlusion of an object by background objects (“background clutter”) might be occurring, and creates an additional (or new) track representation for the object. The additional track representation is added to the set of track representations for the object. The new track representation is updated and maintained as if the object corresponding to the track is being occluded by one or more background objects (“background clutter”). Once the detected occlusion is passed, the track representation that corresponded to the occlusion of the object being tracked by background objects (“background clutter”) is removed from the set of track representations.

A track is associated with one or more foreground areas by matching one of the track representations in the set of track representations for the track to the one or more foreground areas.

All track representations for the track are updated, depending on an event that each track representation is modelling, using the matched one or more foreground areas. Accordingly, the track representation modelling an event affects all track representations in the set of track representations. The track representation that was a successful match to the one or more foreground areas may be deemed to be a “more correct” track representation at a current point in time. Updating the track representations allows state information from the more correct track representations to flow into the other track representations in the same set of track representations.

Existence of certain track representations may affect data association for other track representations in the same set of track representations. For example, knowing that an occlusion of an object by one or more background objects (‘background clutter”) may be occurring, or alternatively that a split event may be occurring, the described methods may determine hints regarding data association when selecting matches between foreground areas and track representations. The hints may be determined using methods such as penalising or favouring selected association hypothesis. The determined hints increase the likelihood of a correct choice, without correspondingly increasing the likelihood of an incorrect choice as much as relaxing the matching threshold would.

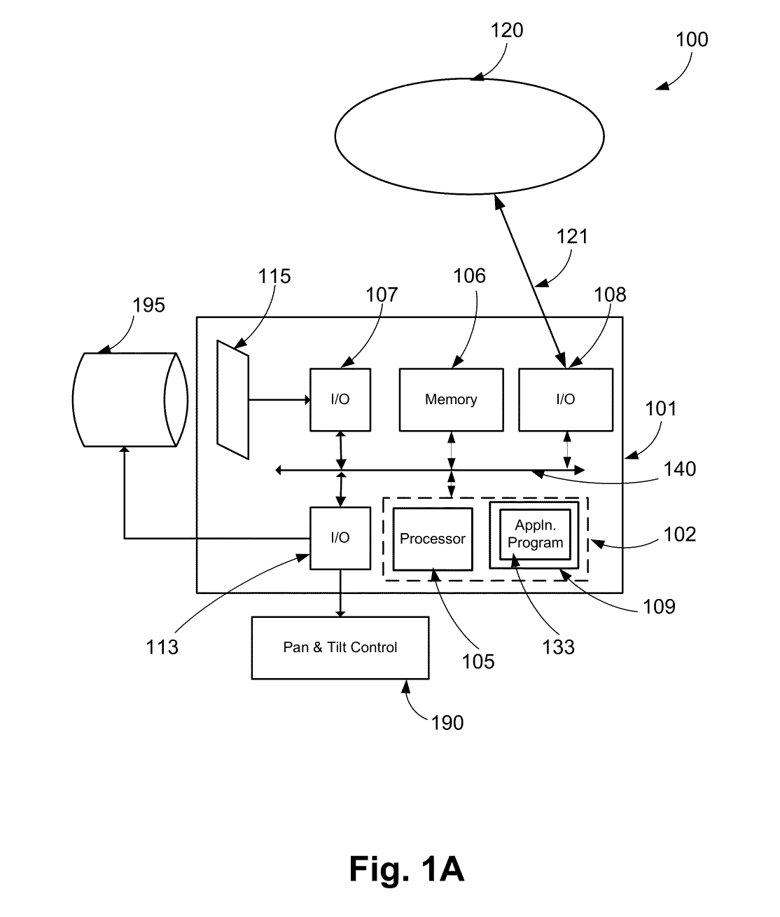

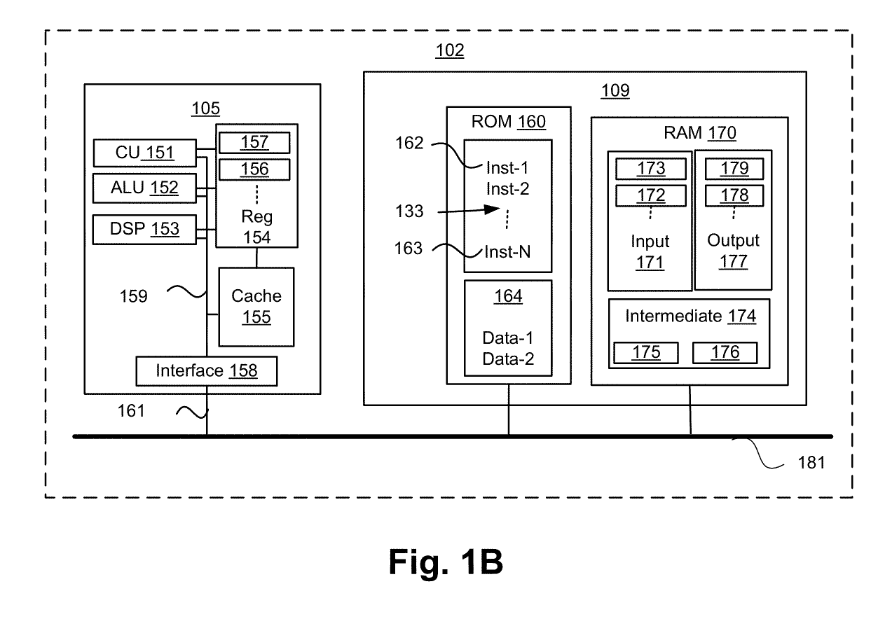

FIGS. 1A and 1B a schematic block diagram of a camera 100, upon which described methods, may be practiced. The camera 100 is a pan-tilt-zoom camera (PTZ). The camera 100 comprises a camera module 101, a pan and tilt module 190, and a lens system 195.

As seen in FIG. 1A, the camera module 101 comprises an embedded controller 102. In the present example, the embedded controller 102 includes at least one processor unit 105 (or processor) which is bi-directionally coupled to an internal storage module 109. The storage module 109 may be formed from non-volatile semiconductor read only memory (ROM) 160 and semiconductor random access memory (RAM) 170, as seen in FIG. 1B. The RAM 170 may be volatile, non-volatile or a combination of volatile and non-volatile memory.

As seen in FIG. 1A, the camera module 101 also comprises a portable memory interface 106 which is coupled to the processor 105. The portable memory interface 106 allows a complementary portable memory device to be coupled to the camera module 101 to act as a source or destination of data or to supplement the internal storage module 109. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The camera module 101 also comprises an input/output (I/O) interface 107 that couples to a photo-sensitive sensor array 115.

The camera module 101 also comprises a communications I/O interface 108 that couples to a communications network 120 via a connection 121. The connection 121 may be wired or wireless. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

The camera module 101 also comprises an I/O interface 113 for the pan and tilt module 190 and the lens system 195.

The components, which include the sensor I/O interface 107, embedded controller 102, communications I/O interface 108, control interface 113 and memory interface 106 of the camera module 101, typically communicate via an interconnected bus 140 and in a manner which results in a conventional mode of operation known to those in the relevant art.

The described methods may be implemented using the embedded controller 102, where the processes of FIGS. 1 to 10 may be implemented as one or more software application programs 133 executable within the embedded controller 102. The camera module 101 of FIG. 1A implements the described methods. In particular, with reference to FIG. 1B, the steps of the described methods are effected by instructions in the software 133 that are carried out within the controller 102. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 133 of the embedded controller 102 is typically stored in the non-volatile ROM 160 of the internal storage module 109. The software 133 stored in the ROM 160 can be updated when required from a computer readable medium. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

The application program 133 is typically pre-installed and stored in the ROM 160 by a manufacturer, prior to distribution of the camera module 101. However, in some instances, the application programs 133 may be supplied to the user encoded on one or more CD-ROM (not shown) and read via the portable memory interface 106 of FIG. 1A prior to storage in the internal storage module 109 or in the portable memory as described above. In another alternative, the software application program 133 may be read by the processor 105 from the network 120, or loaded into the controller 102 or such portable storage medium from other computer readable media. Computer readable storage media refers to any non-transitory tangible storage medium that participates in providing instructions and/or data to the controller 102 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the camera module 101. Examples of transitory or non-tangible computer readable transmission media that may also participate in the provision of software, application programs, instructions and/or data to the camera module 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

FIG. 1B illustrates in detail the embedded controller 102 having the processor 105 for executing the application programs 133 and the internal storage 109. The internal storage 109 comprises read only memory (ROM) 160 and random access memory (RAM) 170. The processor 105 is able to execute the application programs 133 stored in one or both of the connected memories 160 and 170. When the camera module 101 is initially powered up, a system program resident in the ROM 160 is executed. The application program 133 permanently stored in the ROM 160 is sometimes referred to as “firmware”. Execution of the firmware by the processor 105 may fulfil various functions, including processor management, memory management, device management, storage management and user interface.

The processor 105 typically includes a number of functional modules including a control unit (CU) 151, an arithmetic logic unit (ALU) 152, a digital signal processing (DSP) unit 153 and a local or internal memory comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 through 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the camera module 101. Typically, the application program 133 waits for events and subsequently executes the block of code associated with that event. Events may be triggered in response to input from the interfaces 107, 108 and 113 of the camera module 101.

The execution of a set of the instructions may require numeric variables to be read and modified. Such numeric variables are stored in the RAM 170. The described methods use input variables 171 that are stored in known locations 172, 173 in the memory 170. The input variables 171 are processed to produce output variables 177 that are stored in known locations 178, 179 in the memory 170. Intermediate variables 174 may be stored in additional memory locations in locations 175, 176 of the memory 170. Alternatively, some intermediate variables may only exist in the registers 154 of the processor 105.

The execution of a sequence of instructions is achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory address indexed by the program counter is loaded into the control unit 151. The instruction thus loaded controls the subsequent operation of the processor 105, causing for example, data to be loaded from ROM memory 160 into processor registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133, and is performed by repeated execution of a fetch-execute cycle in the processor 105 or similar programmatic operation of other independent processor blocks in the camera module 101. The camera 100 may be used to capture input images representing the visual content of a scene appearing in the field of view of the camera 100. The visual content may include one or more foreground objects and one or more background objects.

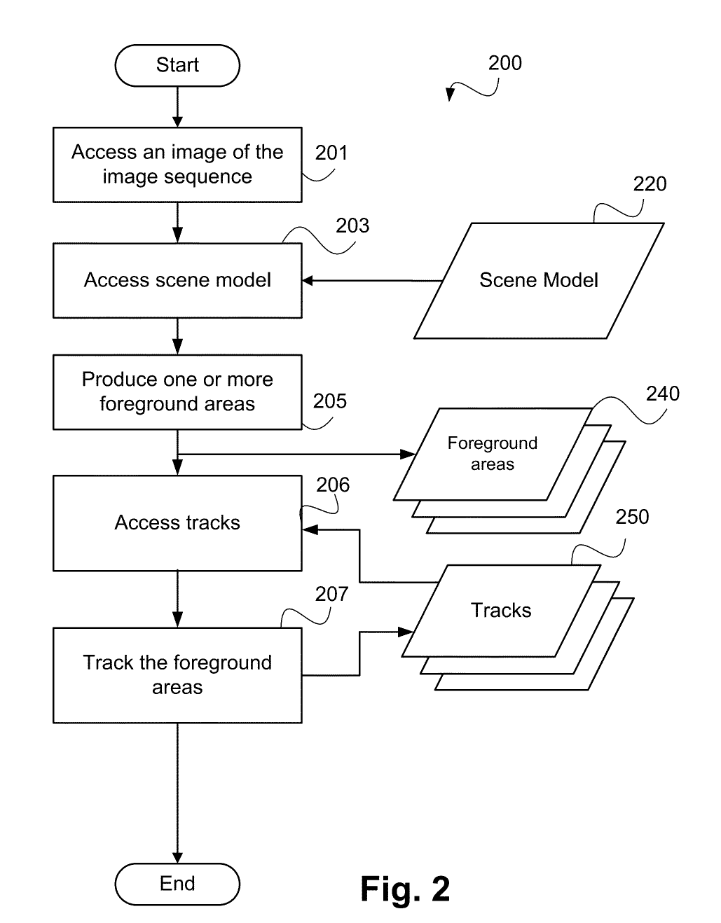

FIG. 2 is a schematic flow diagram showing a method 200 of tracking one or more objects in a sequence of images captured of a scene. The method 200 may be implemented as one or more code modules of the software application program 133 resident in the storage module 109 of the camera 100 and being controlled in its execution by the processor 105.

The method 200 begins at image accessing step 201, where the processor 105 accesses an image of the sequence of images captured by the camera 100. The image may be accessed at step 201 from the storage module 109. For example, the accessed image may have been captured by the camera 100 and stored within the RAM 170 of the storage module 109 prior to execution of the method 200.

At accessing step 203, the processor 105 accesses a scene model for the image. As described above, the scene model is stored information relating to the scene captured in the image and may include foreground information, background information, or a combination thereof. Again, the scene model may be accessed from the storage module 109.

Then at foreground/background separation step 205, the processor 105 executes a foreground/background separation method, using the input image and the scene model accessed at steps 201 and 203, respectively, to produce one or more foreground areas 240 in the input image. The foreground areas 240 may also be referred to as “detections”. As described above, the foreground areas 240 in the input image represent foreground objects of the scene.

Also at step 205, the processor 105 determines relevant statistics corresponding to each foreground area 240. Such statistics may include, for example, the size, age, bounding box of the foreground area, and centroid of the foreground area. The foreground areas and statistics may be stored within the storage module 109.

Also at step 205, the processor 105 updates the scene model for the scene captured in the image, allowing background information for the scene to be learnt over time. Any suitable foreground/background separation method may be used at step 205. For example, background subtraction, a mixture of Gaussians, or other methods of foreground separation using background modelling, may be executed by the processor 105 at step 205.

At accessing step 206, the processor 105 accesses a set of tracks 250 associated with one or more objects within the image. The set of tracks 250 may have been stored within the storage module 109, for example, together with the scene model, prior to execution of the method 200.

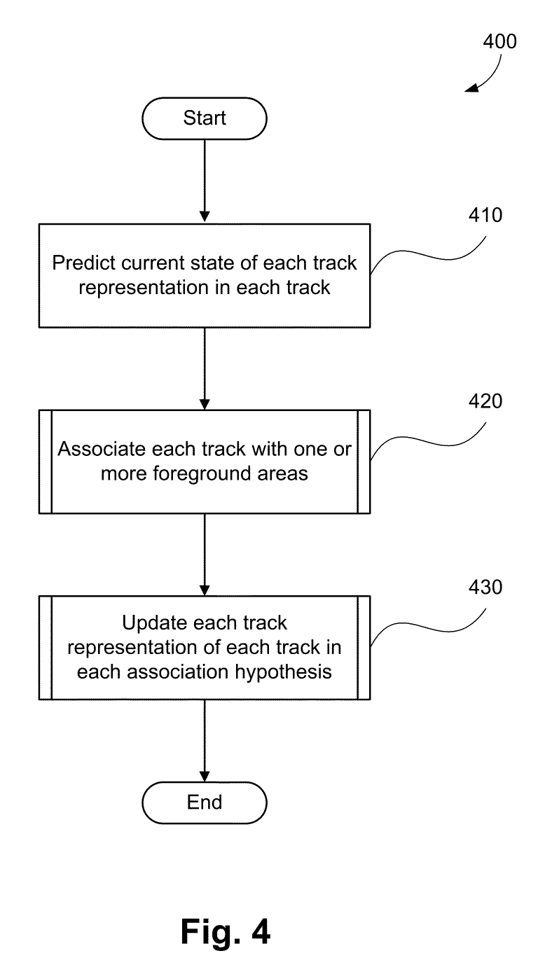

At tracking step 207, the processor 205 performs tracking of the foreground areas 240 generated at step 205 using the set of tracks 250. Tracks in the set of tracks 250 are updated and maintained by the processor 105 as part of step 207. A method 400 of “geometric” tracking of foreground areas, as executed at step 207, will be described in detail below with reference to FIG. 4.

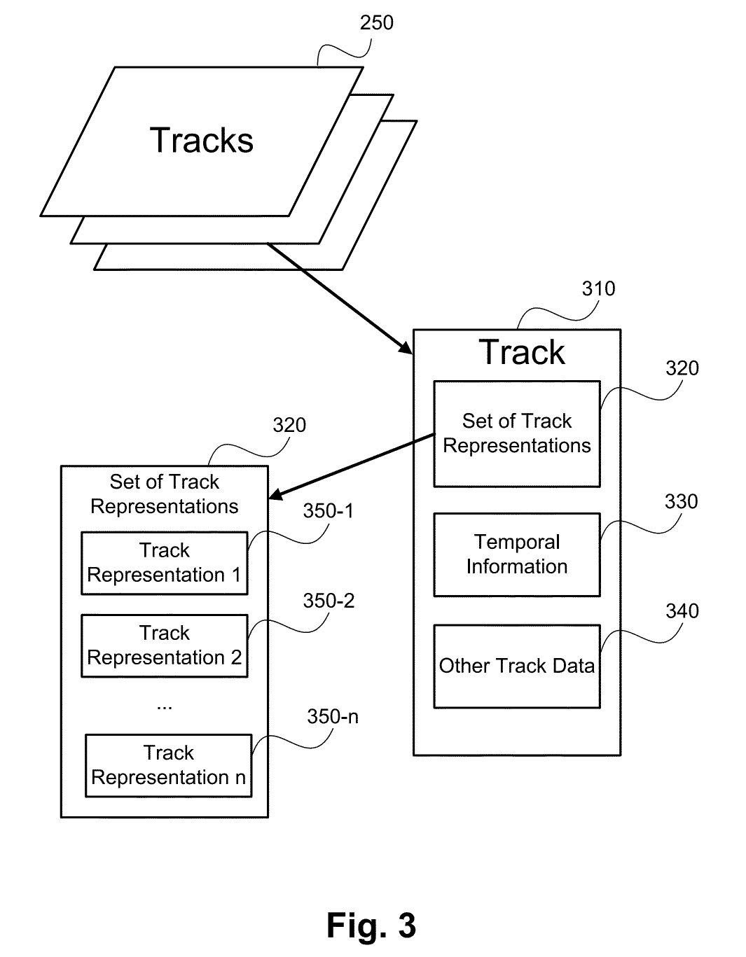

FIG. 3 is a schematic block diagram showing an example of a track 310 of the set of tracks 250 used at step 207. The methods will be described below by way of example where the track 310 is associated with the object being tracked by the method 200.

Each track 310 of the set of tracks 250 has a set of track representations 320. The set of track representations 320 contains at least one track representation (e.g., 350-1), with extra track representations (e.g., 350-2 to 350-n) being created and deleted at step 207 as required. A track representation 350-1 contains an estimation of the state of the track 310, including a location of a bounding box corresponding to the foreground area (e.g. a location of centre point of the bounding box), a shape of the bounding box corresponding to the foreground area (e.g. height of the bounding box, width of the bounding box) and velocity of a centre position of the foreground area. In another arrangement, each track representation 350-1 may use the centroid of the foreground area instead of the centre of the bounding box corresponding to the foreground area. In another arrangement, each track representation 350-1 may include a quantised histogram of luminance and a quantised histogram of hue of the foreground area, where the hue is an angle formed by a vector (chrominance red, chrominance blue). In another arrangement, each track representation 350-1 may include texture information of the foreground area.

The track 310 may have more than one track representation in the set of track representations 320 associated with the track 310 when there is uncertainty about the state of the track 310. For example, the tracking performed at step 207 may detect that there has been an occlusion of the object in the scene by one or more background objects (“background clutter”).

As another example, the tracking performed at step 207 may detect that the track 320 associated with the object may be splitting into two or more tracks.

The foreground areas 240 produced by the foreground/background separation method executed at step 205 and the set of tracks 250 stored within storage module 109, and updated during step 207, may be used for further processing as part of video analytics. For example, the foreground areas 240 and tracks 250 may be used to detect abandoned objects, removed objects, loitering, congestion, and other high level events that might be of interest.

As seen in FIG. 3, each track 310 in the set of tracks 250 also contains temporal information 330 about the track 310, such as, a window of when the track 310 was last matched to one or more foreground areas 240 (or “detections”). Each track 310 may also contain other information 340 about the track 310, as required, such as, a unique track identifier used to uniquely identify the track 310.

As described above, the set of track representations 320 contains one or more track representations 350-1, 350-2 and 350-n. The track representations 350-1, 350-2 and 350-n are added to, and deleted from, the set of track representations 320 as required. Each track representation (e.g., 350-2), apart from the “normal” track representation (e.g., 350-1) described above, models an event which may be detected by the tracking performed at step 207. The detected event may affect quality of the foreground areas 240, or quality of the tracking. The “normal” track representation (e.g., 350-1) models the track 310 as if the corresponding object being tracked is moving through the scene consistently, without being occluded by either background objects (“background clutter”) or other objects, and with no errors affecting detection.

There are different types of track representations 350-1, 350-2 and 350-n, with each type of track representation (e.g., 350-1) modelling a hypothesised state of the track 310. The type of a particular track representation (e.g., 350-1) added to the set of track representations 320 is dependent upon a detected event that caused the track representation 350-1 to be created. The event may or may not be occurring. The existence of the track representation 350-1 represents a hypothesis during the tracking step 207 that the event is occurring. The behaviour and treatment of the track representation reflects the event that the track representation is modelling.

Examples of events which may be detected by the tracking step 207 include occlusion of the object being tracked by one or more background objects (“background clutter”) and track fragmentation/splitting.

Each track representation (e.g., 350-1) contains a hypothesised state of the track 310. The hypothesised state includes height, width and location of the track 310. The track representation 350-1 may also store a window of last matched locations to determine an estimated velocity of the track representation 350-1. In one arrangement, a track representation 350-1 includes a visual signature of the track 310, such as a colour histogram. In another arrangement, a track representation 350-1 may include a centroid of the track 310.

FIG. 4 is a schematic flow diagram showing a method 400 of “geometric” tracking of foreground areas, as executed at step 207. The method 400 processes foreground areas associated with one image, which is the image accessed at step 201. The method 400 may be implemented as one or more code modules of the software application program 133 resident in the storage module 109 of the camera 100 and being controlled in its execution by the processor 105.

The method 400 begins at prediction step 410, where the processor 105 predicts the current state of each track representation 350-1, 350-2 to 350-n in the set of track representations 320 for each track 310 of the set of tracks 250.

The predicted state of a track representation (e.g., 350-1) is based on velocity of the track representation 350-1, previous states of the track representation 350-1 and elapsed time since a last observation.

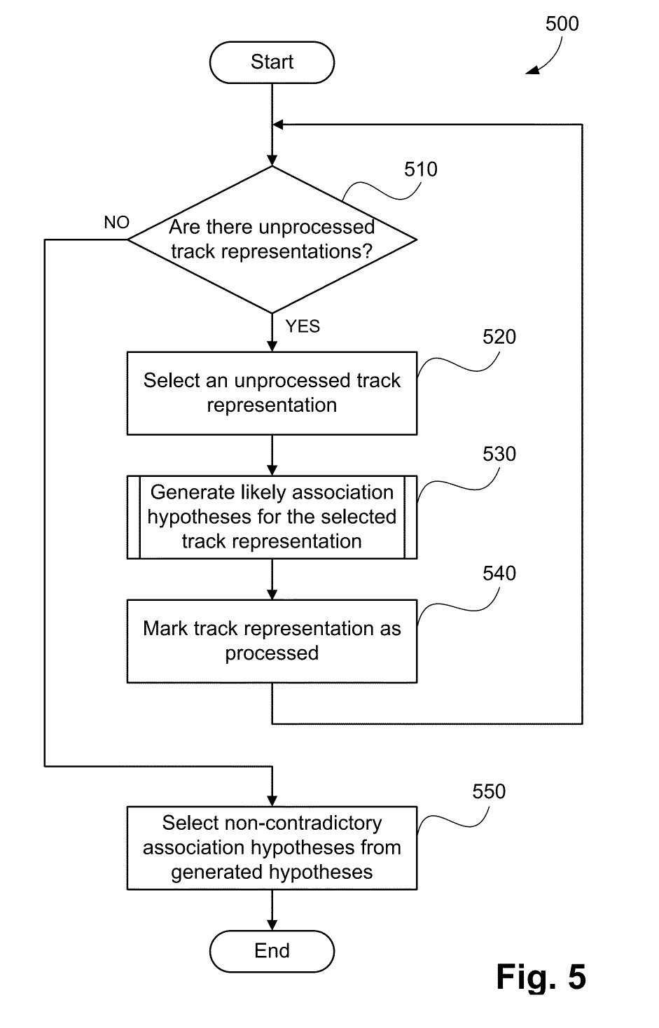

At data association step 420, the processor 105 associates each of the tracks 310 of the set of tracks 250 with one or more of the foreground areas 240. In particular, the processor 105 creates a list of “association hypotheses” which may be stored within the RAM 170 of the storage module 109. As described below, the list of association hypotheses is reduced to a non-contradictory set of association hypotheses. An association hypothesis is a likely combination of one or more track representations (e.g., 350-1) and one or more of the foreground areas 240 (or “detections”). In the non-contradictory set of association hypotheses, each track 310 will have at most one track representation (e.g., 350-1) in the non-contradictory list, and each foreground area of the foreground areas 240 (or “detections”) will be in the non-contradictory set at most once. Each association hypothesis in the resultant non-contradictory set of association hypotheses therefore contains a set of matching tracks 310 and foreground areas. A method 500 of associating one or more of the foreground areas 240 with tracks 310, as executed at step 420, will be described in detail below with reference to FIG. 5.

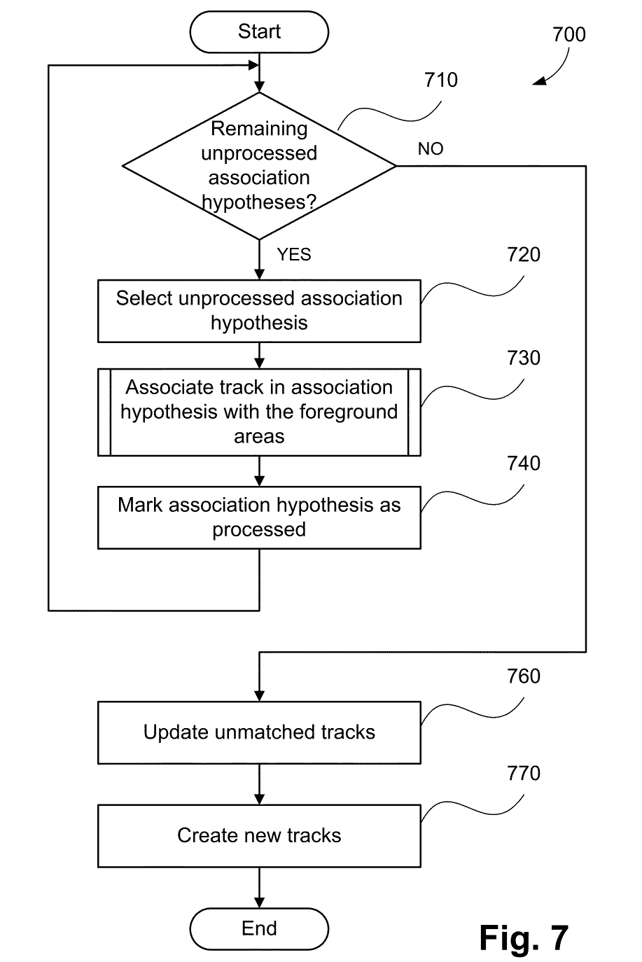

At track management step 430, the processor 105 takes each association hypothesis in the resultant non-contradictory list of association hypotheses stored within the storage module 109. The processor 105 uses the one or more foreground areas (or “detections”) in each association hypothesis to update each track representation 350-1, 350-2 and 350-n in the one or more tracks 310 in the same association hypothesis. A method 700 of updating each track representation (e.g., 350-1), as executed at step 430, will be described in detail below with reference to FIG. 7.

The method 500 of associating one or more of the foreground areas 240 with tracks 310 of the set of tracks 250, as executed at step 420, will now be described in detail below with reference to FIG. 5. The method 500 may be implemented as one or more code modules of the software application program 133 resident in the storage module 109 of the camera 100 and being controlled in its execution by the processor 105. The method 500 begins at decision step 510, where if the processor 105 determines that all of the track representations 350-1, 350-2 to 350-n in the set of track representations 320 for each track 310 in the set of tracks 260 have been processed, then the method 500 proceeds directly to step 550. Otherwise, if there are remaining unprocessed track representations 350-1, 350-2 to 350-n, then the method 500 proceeds to selecting step 520.

At selection step 520, the processor 105 selects an unprocessed track representation (e.g., 350-1).

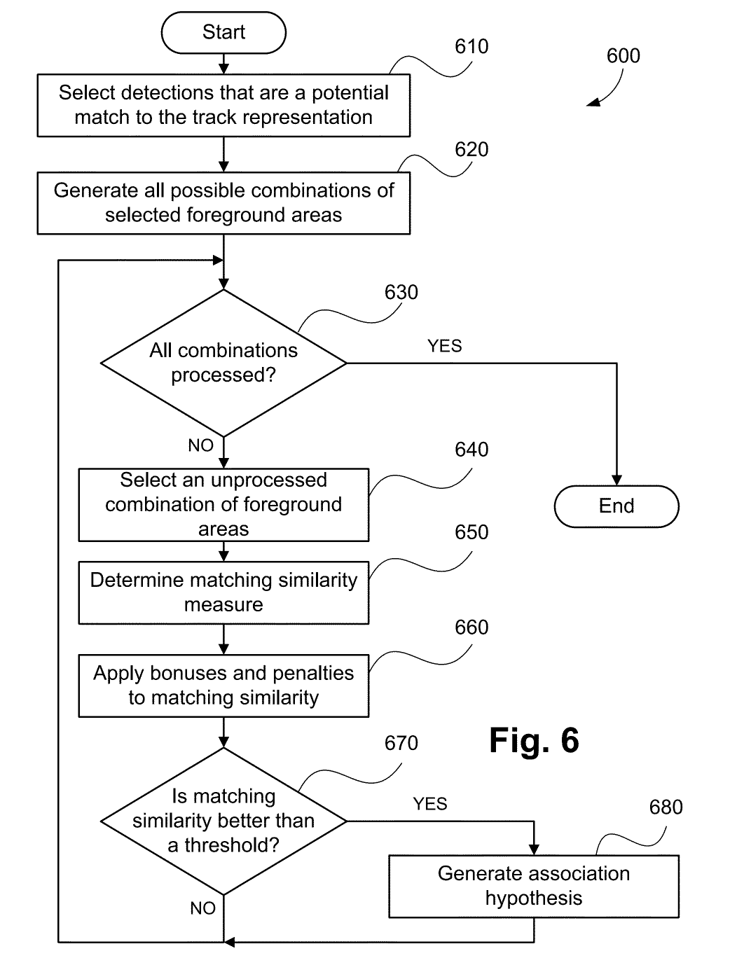

Then at generation step 530, the processor 105 generates a likely association hypotheses for the track representation 350-1 selected at step 520. In particular, at step 530, the processor 105 takes the track representation 350-1 selected at step 520 and combines the selected track representation 350-1 with likely combinations of the foreground areas 240. Any combination of track representation 350-1 and one or more of the foreground areas 240 that is more likely than a set threshold, for example, may be combined into an association hypothesis. The determined association hypothesis is added to the list of association hypotheses created at step 420. A method 600 of generating likely association hypotheses for the selected track representation 350-1, as executed at step 530, will be described in detail below with reference to FIG. 6.

In an alternative arrangement, multiple tracks 310 may be matched with one or more of the foreground areas 240 in an association hypothesis.

At marking step 540, the processor 105 marks the track representation selected at step 520 as processed.

Following step 540, the method 500 returns to the decision step 510. As described above, if the processor 150 determines that there are no remaining unprocessed track representations 350-1, 350-2 to 350-n, then the method 500 continues to selection step 550.

As described above, the association hypotheses are generated independently for each combination of one or more foreground areas (or “detections”) and, in one arrangement, one or more track representations 350-1, 350-2 to 350-n. Accordingly, some association hypotheses attempt to associate the same foreground area, or even the same combination of foreground areas, to different track representations 350-1, 350-2 to 350-n. Such contradictions may be undesirable. Thus, in one arrangement, step 550 may be used to reduce the list of association hypotheses to an optimal set of association hypotheses. In such an optimal set, each foreground area appears in at most one association hypothesis. Further, each track 310, by way of one corresponding track representation (e.g., 350-1)_from the set of track representations 320 for that track 310, appears in at most one association hypothesis. In one arrangement, a Global Nearest Neighbour (GNN) method may be used to reduce the list of association hypotheses. Global Nearest Neighbour is an iterative algorithm that may be used to select an association hypothesis with a best likelihood of being correct and place the selected association hypothesis in the optimal set. All other association hypotheses that contain the same track 310, by way of the corresponding track representation (e.g., 350-1), or any of the foreground areas represented by the selected association hypothesis, are then deleted from the list of association hypotheses stored in the storage module 109, as subsequently selecting the association hypotheses would create contradictions. In an alternative arrangement, every possible combination of association hypotheses may be evaluated to procedurally determine an optimal non-contradictory subset of association hypotheses according to a similarity measure. However, evaluating every possible combination of association hypotheses may be very computationally expensive. Thus, step 550 results in a non-contradictory set of association hypotheses that is a subset of the list of association hypotheses resulting from step 530. In the non-contradictory subset of association hypotheses, each of the foreground areas 240 in the image appears in at most one association hypothesis and each track, by way of a corresponding track representation, appears in at most one association hypothesis.

In another arrangement, a foreground area may be matched to multiple representations from different tracks 310. In still another arrangement, multiple tracks 310 may be matched to multiple foreground areas of the foreground areas 240 in the image.

The method 600 of generating association hypotheses for a track representation (e.g., 350-1), as executed at step 530, will now be described in detail below with reference to FIG. 6. The method 600 may be implemented as one or more code modules of the software application program 133 resident in the storage module 109 of the camera 100 and being controlled in its execution by the processor 105. The method 600 begins at selection step 610, where the processor 105 identifies which of the foreground areas 240 may be part of a likely match for the track representation (e.g., 350-1) selected in step 520. The identified foreground areas may be added to a list of selected foreground areas configured within the storage module 109.

In one arrangement, the processor 105 may use an ideal spatial extension to create an extended spatial representation of a particular foreground area at step 610, in order to determine a likely match for the selected track representation 350-1. Ideal spatial extension extends a spatial representation of the foreground area such that the centre point of the foreground area moves towards, but not past, the centre point of the selected track representation 350-1. The height and the width of the foreground area are extended until the height and width of the foreground area are the same size as the height and width, respectively, of the track representation (e.g., 350-1) selected in step 520. If a dimension of the foreground area is larger than the corresponding dimension of the selected track representation 350-1, then the dimension of the foreground area is not extended.

After the foreground area has undergone ideal spatial extension, a matching similarity measure may be determined between the extended spatial representation of the foreground area and a prediction of the selected track representation 350-1 (also known as the expectation), as predicted in step 410. In one arrangement, the similarity measure may be a gating distance used by an Alpha Beta Filter based tracker. In another arrangement, the similarity measure may be a gating distance used by a Kalman Filter based tracker. In yet another arrangement, the similarity measure may be the gating distance used by a multi-state Alpha Beta Filter based tracker, which approximates a Kalman filter with a limited number of states before reaching a Cramer-Rao lower bound. In yet another arrangement, the similarity measure may be a fraction representing the area of overlap divided by total area occupied by the extended spatial representation of the foreground area and the spatial prediction of the selected track representation 350-1. In still another arrangement, the similarity measure may be a sum of the discrepancies of edge positions.

The gating distance may be used to track rectangular objects with four components: location (x, y) and dimension (width, height).

As an example, let the extended spatial representation of the foreground area have coordinates (x_representation, y_representation) and dimensions (w_representation, h_representation). Similarly, let the spatial prediction of the selected track representation 350-1 have coordinates (x_expectation, y_expectation) and dimensions (w_expectation, h_expectation).

In one arrangement, the similarity measure determination may also require predetermined variances in order to determine the gating distance. In such an arrangement, the predetermined variances may be determined prior to performing the tracking in step 260, by firstly generating foreground areas from pre-recorded image sequences that together form a training set. Statistical variances may be determined representing error for the location, height and width.

Let the predetermined variance \hat{x} denote the statistical variance of the horizontal distance between the centre of the spatial representation of the foreground area and the centre of the spatial representation of the predicted track representation 350-1.

In one arrangement, the predetermined variance \hat{x} is determined from a set of training data. The predetermined variance \hat{x} is calculated by first determining the difference between the horizontal location of the spatial representation of the expectation and the horizontal location of the spatial representation of a foreground area. Determination of such a difference may be repeated for the associated foreground areas and track representations in the training set. Then, each difference may be squared, and the squares summed over multiple foreground areas from the training data. Finally, the sum of the squares may be divided by the number of differences. Statistical variance ŷ of the vertical distance may be determined in a similar manner, using the difference in the vertical locations. The statistical variance ŵ of the difference in the width is determined in a similar manner, using the difference in widths. The statistical variance ĥ of the difference in the height is determined in a similar manner, using the difference in heights.

Then, given the predetermined variances, the gating distance, dist, may be determined in accordance with Equation (1), as follows:

$$dist = \frac{{( x\_representation - x\_expectation )}^{2}}{\hat{x}} + \frac{{( y\_representation - y\_expectation )}^{2}}{\hat{y}} + \frac{{( w\_representation - w\_expectation )}^{2}}{\hat{w}} + \frac{{( h\_representation - h\_expectation )}^{2}}{\hat{h}} \qquad ( 1 )$$

The gating distance, dist, determined in accordance with Equation (1) produces a numerical result which is small if the extended spatial representation of the foreground area and the spatial prediction of the selected track representation 350-1 are similar. The gating distance, dist, is large if the extended spatial representation of the foreground area 240 and the spatial prediction of the selected track representation 350-1 are dissimilar. In one arrangement, the gating distance, dist, may be converted into a similarity measure, sim. In this instance, a large similarity measure, sim, represents high similarity between the extended spatial representation of the foreground area 240 and the spatial prediction of the selected track representation. In one arrangement, the following transformation function of Equation (2) is applied:

$$sim = \frac{1}{dist + 1} \qquad ( 2 )$$

The similarity measure, sim, has some important properties. Statistically, the distance between the spatial prediction of the selected track representation 350-1 and the spatial representation of a non-fragmented one of the foreground areas 240 is within approximately one standard deviation. Dividing the square of the difference of each component (e.g., (x_representation−x_expectation)²) by the variance (e.g., \hat{x}), scales error such that the contribution to the gating distance, dist, is 1.0 unit for each component (i.e., x_representation, y_representation) and dimensions (w_representation, h_representation). The determined gating distance, dist, should be less than the number of measured components (i.e., four (4.0) components in this arrangement), if the spatial representation of the foreground area corresponds to the spatial prediction of the selected track representation 350-1. Thus, the similarity measure, sim, is expected to be larger than 0.2 if the extended spatial representation of the foreground area corresponds to the spatial prediction of the selected track representation 350-1. Where the properties of the camera 100 have been measured to give the variances, the value of 0.2 is optimal, in the Bayesian sense.

The similarity measure, sim, may then be used in a similarity threshold test. In one arrangement, if the value of the similarity measure, sim, determined for the foreground area is greater than a predetermined representation similarity threshold, say 0.3, then the foreground area is added to the list of selected foreground areas configured within the storage module 109 at step 610. In another arrangement, a predetermined optimal value of the similarity measure may be used, (e.g. 0.2) at step 610. In still another arrangement, if the gating distance dist determined for the foreground area is less than a threshold (e.g., 4.0), then the foreground area is added to the list of selected foreground areas at step 610.

Step 610 may thus be first seen to be identifying and then selecting foreground areas that are both a likely fragment of, and a likely direct match to, the selected track representation 350-1; and then secondly seen to be selecting foreground areas that are likely fragments of the selected track representation 350-1.

At generation step 620, the processor 105 generates all possible combinations of selected foreground areas, including combinations consisting of just one foreground area. In one arrangement, the total number of selected foreground areas per combination may be limited to a maximum value (e.g., six (6) foreground areas). In another arrangement, the total number of selected foreground areas may be limited to a maximum value (e.g., eight (8)).

In one implementation, the processor 105 generates combinations of foreground areas that contain at most one foreground area at step 620, if the selected track representation 350-1 was created due to a fragment/split event being detected.

At decision step 630, if the processor 105 determines that not all combinations of foreground areas generated at step 620 are processed, then the method 600 continues to step 640. Otherwise, the method 600 concludes.

At selection step 640, the processor 105 selects an unprocessed combination of foreground areas in the list of foreground areas, and marks the unprocessed combination of foreground areas as processed.

Then at step 650, the processor 105 determines a matching similarity measure for the selected combination of foreground areas and the selected track representation 350-1. The matching similarity measure used at step 650 is the same matching similarity measure, dist, as described above with reference to step 610. The height, width and location for the combination of foreground areas that is used in determining the matching similarity measure is obtained by creating a tight bounding box around the combination of foregrounds areas.

At applying step 660, the processor 105 applies selected bonuses and penalties to the matching similarity measure, based on heuristics, to create a final similarity measure. In one arrangement, a first bonus and a second bonus, and a first penalty, are applied to the matching similarity measure at step 660. In another arrangement, a combination of the bonuses and penalties, or other bonuses and penalties, may be applied to the matching similarity measure at step 660.

The first bonus is applied to the matching similarity measure based on the number of foreground areas in the combination of foreground areas selected at step 640. For example, the similarity measure may be decreased by 0.1 per foreground area in the combination of foreground areas selected at step 640. The purpose of the first bonus is to encourage association hypotheses that include all fragments of the object being tracked in accordance with the method 200 to be selected at step 550. Outlying fragments that are not present in the selected set of non-contradictory association hypotheses may spawn extraneous noisy tracks.

The second bonus may be applied to the matching similarity measure based on the track representations in the set of track representations and the edge of the bounding box around the combination of foreground areas selected at step 640.

The second bonus is applied to the matching similarity measure if the following two conditions are met. The first condition is that the track representation selected at step 520 is in a set of track representations that includes at least one track representation that is modelling the hypothesis that the object being tracked is being occluded by background clutter of the scene being captured by the camera 100. The second condition compares the corresponding edge of the bounding box around the combination of foreground areas selected at step 640 to the location at where the occlusion was detected. If the corresponding edge of the bounding box around the combination of foreground areas selected at step 640 is beyond the occlusion, then the second condition is met. In another arrangement, the difference between the corresponding edge of the bounding box around the combination of foregrounds areas selected at step 640 and the location of the occlusion is greater than a threshold. An example of the application of the second bonus is decreasing the matching similarity measure by 0.5.

The first penalty may be applied to the matching similarity measure based on the track representations in the set of track representations selected at step 520 and the edge bounding box around the combination of foreground areas selected at step 640. The first penalty may be applied to the matching similarity measure if the following two conditions are met. The first condition is that the track representation selected at step 520 is in a set of track representations that includes at least one track representation that is modelling the hypothesis that the object being tracked is being occluded by one or more background objects (“background clutter”). The second condition compares the corresponding edge of the bounding box around the combination of foreground areas selected at step 640 to the location at where the occlusion was detected. If the corresponding edge of the bounding box around the combination of foreground areas selected at step 640 is at the same location as the occlusion, then the second condition is met. In another arrangement, the difference between the corresponding edge of the bounding box around the combination of foreground areas selected at step 640 and the location of the occlusion must be less than a threshold. An example of the application of the first penalty is increasing the matching similarity measure by 0.5.

In another arrangement, a bonus is given to track representations modelling fragments if relative movement of the other track representations modelling fragments is not consistent. The matching similarity measure after all bonuses and penalties are applied may be referred to as a final matching similarity measure.

After step 660, the method 600 continues to a threshold decision step 670. In another arrangement, step 670 is performed before step 660, and the matching similarity measure is used instead of the final matching similarity measure for step 670.

At decision step 670, the processor 105 compares the value of the final matching similarity measure to a threshold value. If the value of the matching similarity measure is less than the threshold value, then the method 600 continues to association hypothesis step 680. Otherwise, the method 600 returns to step 630.

At step 680, the processor 105 creates an association hypothesis and adds the association hypothesis created to the list of association hypotheses configured within the storage module 109. The list of association hypotheses generated at generating step 680 is used at selecting step 550 to reduce the list of association hypotheses to a non-contradictory set of association hypothesis. The added association hypothesis represents a hypothesis that the combination of foreground areas selected at step 640 match the selected track representation 350-1. The association hypothesis includes the foreground areas in the combination of foregrounds areas selected at step 640, the selected track representation 350-1, the track that the selected track representation corresponds to, and the final matching similarity measure.

The method 700 of updating each track representation (e.g., 350-1) of the set 320 of track representations, as executed at step 430, will now be described with reference to FIG. 7. As described below, one or more track representations of the set 320 are deleted if a modelled event is false. The method 700 may be implemented as software resident within the storage module 109 of the camera 100 and being controlled in its execution by the processor 105 of the camera 100.

The method 700 begins at decision step 710, where if the processor 105 determines that there are remaining unprocessed association hypotheses in the non-contradictory set of association hypotheses generated at step 550, then the method 700 proceeds to step 720. Otherwise, the method 700 proceeds directly to step 760.

At selecting step 720, the processor 105 selects an unprocessed association hypothesis from the non-contradictory set of association hypotheses stored within the storage module 109.

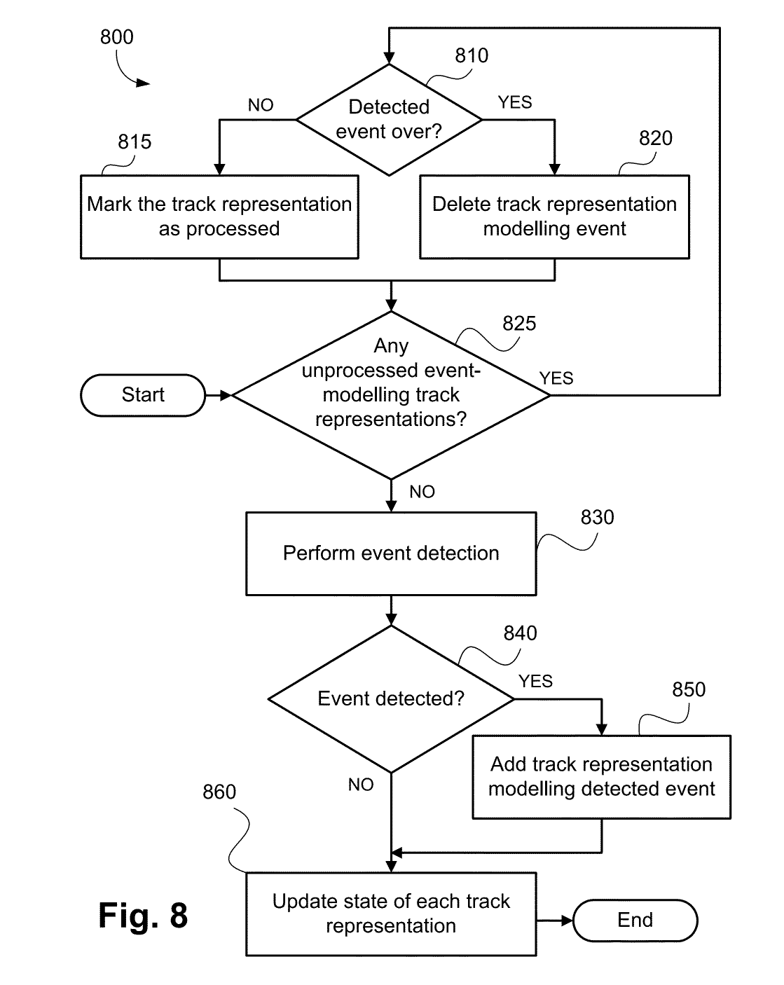

Then at association step 730, the processor 105 associates the track 310 from the association hypothesis selected at step 720 with the foreground areas from the selected association hypothesis. Also at step 730, the processor 105 updates all track representations in the set 320 of track representations corresponding to the track 310 from the selected association hypothesis. The processor 105 detects events which may be affecting the detection of the object being tracked, such as occlusion of the object by one or more background objects (“background clutter”) or fragmentation/splitting. One or more new track representations that model the detected event are also created and stored at step 730. If a previously detected event is over, for example, the object being tracked has been detected as having moved beyond occlusion of the object by one or more background objects (“background clutter”), the object has been confirmed as having split into two objects, or the detection of the object is no longer fragmented, then the corresponding track representations that modelled that event are deleted from the set of track representations 320 associated with the object. Each track representation (e.g., 350-1) in the set of track representations 320 for the track 310 being updated is then updated using the foreground areas from the association hypothesis selected at step 720. The track representations 320 are updated, including updating the height, width, location and velocity, depending on the event that the track representation 320 is modelling. A method 800 of updating a track, as executed at step 730, will be described in detail below with reference to FIG. 8.

At marking step 740, the processor 105 marks the association hypothesis selected at step 720 as processed.

At update step 760. the processor 105 updates all track representations 350-1 for each track 310 that has not been matched to one or more of the foreground areas 240 (i.e., the track 310 is not in one of the association hypotheses in the non-contradictory set of association hypotheses). The predicted states of the track representations of any unprocessed track, as predicted at step 410, becomes the new state for each corresponding track representation.

At create step 770, the processor 105 creates a new track for each foreground area that has not been matched to a track 310 (i.e., the foreground area is not in one of the association hypotheses in the non-contradictory set of association hypotheses). The new track created for a foreground area will initially have one track representation in the set of track representations 320 (i.e., the “normal” track representation), which models an unoccluded track moving through the scene.

The method 800 of updating a track, as executed at step 730, will now be described in detail with reference to FIG. 8. The method 800 may be implemented as software resident within the storage module 109 of the camera 100 and being controlled in its execution by the processor 105 of the camera 100.

In accordance with the method 800, the track 310 corresponding to the unprocessed association hypothesis selected at step 720 is updated by considering the detection of certain events. The events considered at step 730, include, but are not limited to, detecting occlusion of an object being tracked by other background objects and fragmentation or splitting of the track. Other events affecting detection of the object being tracked can benefit from the method 800. For example, consider a fragmentation or split event. When fragmentation is observed (i.e., the selected association hypothesis contains more than one associated foreground area), it is unknown at the time whether the observation of the track 310 is fragmented due to a misdetection (e.g., as a result of partial occlusion), or if the object being tracked has split into two objects, each of which should be tracked individually. Thus, when fragmentation is observed, track representations 350-1 may be created for the foreground areas in the selected association hypothesis.

By creating a track representation (e.g., 350-1) for each fragment, relative motions of the track representations to each other may be contrasted with the “normal” track representation. If the track 310 is splitting, the track representations associated with each fragment will be moving apart. If the track 310 is merely fragmented due to a misdetection or partial occlusion of the object being tracked, then the motion of the group of track representations is fairly consistent. Once a final decision is made regarding the status of the track representations, then those tracks 310 deemed to be false may be deleted.

The method 800 begins at decision step 825. At decision step 825, the processor 105 determines if there are any unprocessed track representations (modelling detected events) contained within the set of track representations 320 for the track 310 associated with the association hypothesis selected at step 720. If there are no unprocessed track representations that model detected events, then the method 800 continues to event detection step 830. Otherwise, the method 800 continues to decision step 810.

At step 810, if the processor 105 determines that there is enough evidence to declare that the detected event is finished or false, then the method 800 continues to delete step 820. Otherwise, the method 800 continues to step 815. The processor 105 makes the determination at step 810 using any suitable method. For example, the processor 105 may determine that the track representation associated with an occlusion (“occlusion track representation”) has not been matched to any foreground areas for a number of previous frames, (e.g., five (5) previous frames), since the edge of the track has passed where the occlusion of the tracked object was detected. In this case, the hypothesis of the event occurring may have been shown to be correct. For example, the track representation associated with the occlusion of the object may have been matched to foreground areas one or more times. In this instance, the processor 105 may determine that detected event is finished and the method 800 proceeds to step 820.

As another example, the hypothesis of the event occurring may continue to be ambiguous. Consider occlusion of the object being tracked by one or more background objects (“background clutter”). If the occlusion track representation has not yet passed, then the location of such an occlusion, and the occlusion track representation has not been matched to a foreground area. It is also unknown if the hypothesis of the event occurring is correct or incorrect. Further, if the hypothesis was correct, then it is unknown if the event has completed. In this instance, the method 800 proceeds to step 815.

As yet another example, the event may be passed. Consider occlusion of the object being tracked by one or more background objects (“background clutter”). If the object being tracked has passed the background objects occluding the object, then the occlusion by background clutter event may be considered to be finished, even if the occlusion track representation was never matched to a foreground area. In this instance, the processor 105 may determine that detected event is finished and the method 800 proceeds to step 820.

In the case of fragmentation, the event has finished either when the object is again detected as only one foreground area, or the relative movement of the fragments have confirmed that a split has occurred.

At delete step 820, the processor 105 deletes the track representation(s) 350-1 corresponding to the detected event from the set 320 of track representations. Accordingly, an occluded track representation is deleted if the hypothesis is false.

At step 815, the track representation corresponding to the detected event is marked as processed.

Then at decision step 825, if there are no unprocessed track representations that model detected events, then the method 800 continues to event detection step 830. Otherwise, the method 800 returns to step 810.

At event detection step 830, the processor 105 attempts to detect an event which may affect accuracy when attempting to track the foreground areas that correspond to the object being tracked. An example of relevant events are those events which affect the detection of the object, such as occlusion of the object by one or more background objects, fragmentation and areas of noisy foreground areas. Other examples of relevant events are those which affect the tracking of the foreground areas, such as egress from the scene, unexpected movement and splitting. For example, a fragmentation/split event may be detected when the association hypothesis selected at step 720 contains more than one foreground area. Detection of an event at step 830 will be described in more detail below.

At decision step 840, if the processor 105 determines that an event has been detected at step 830, then the method 800 continues to add track representation step 850. Otherwise, the method 800 proceeds to update step 860.

The detection of a possible event at step 830 and subsequent creation of one or more corresponding track representations at step 850 represents a hypothesis, which cannot be confirmed or rejected at this point in time, that the object being tracked may be subject to that event. If the object being tracked is not actually undergoing the detected event, there is no reduction in accuracy of the tracking method 200 being executed on the camera 100.

As an example, the method 200 may detect a possible occlusion of the object being tracked by a background clutter event. If the hypothesis of the occlusion of the object by one or more background objects (“background clutter”) is correct, and the object being tracked is being occluded by one or more background objects, then the foreground areas at some point will be a match to the track representation (e.g., 350-1) that is modelling the occlusion of the object being tracked by one or more background objects. Such a match provides positive confirmation of a detected event to the method 200. If the positive confirmation occurs prior to, or at the same time as, confirmation that the object being tracked has passed the location where the occlusion of the object was detected, then the processor 105 may delay the deletion of the track representation that is modelling the occlusion of the object for a period of time. For example, the deletion of the track representation may be delayed for ten (10) images in a sequence (or frames).

When the track representation that is modelling occlusion of the object is matched (i.e., the track representation modelling the occlusion of the object is in an association hypothesis that is included in the non-contradictory set), then the foreground areas are providing evidence that the correct track representation (e.g., 350-1) is the track representation modelling the occlusion of the object being tracked by one or more background objects (“background clutter”). All of the track representations in the set of track representations for the corresponding track may then be updated using the foreground areas that matched the occlusion track representation, the correct state of the occlusion track representation corresponding to the occlusion of the object can allow the other track representations to gradually learn the correct state of the object being tracked by updating the corresponding state values according to the foreground areas associated with the object. Once the state of the track representation that models “normal” movement of objects has adjusted to correctly follow the object as the object leaves the occlusion by one or more background objects (“background clutter”), the track representation (e.g., 350-1) associated with the occlusion is no longer required and can be safely deleted. The data association step 420 will again successfully match the “normal” track representation with the foreground areas corresponding to the correct object being tracked.

If the hypothesis that the object being tracked is being occluded by one or more background objects (“background clutter”) is incorrect (or “false”), then the foreground areas will not match the track representation (e.g., 350-1) associated with the occlusion of the track representation. The occlusion track representation can then be safely deleted, with no impact on accuracy of the tracking. Therefore, the described methods are robust to false detections of occlusion of the object being tracked by one or more background objects (“background clutter”).

Detection of events may be biased to give positive detection of events rather than failed detection of events. False positives (e.g., detecting an occlusion of the object by background clutter where the object was not occluded), will rarely affect the described methods in a negative manner. However, false negatives, such as failing to detect a genuine occlusion of the object being tracked by one or more background objects (“background clutter”), may still result in the described methods being less robust to the event being detected.

At add track representation step 850, the processor 105 performs the step of adding one or more track representations (e.g., 350-1) to the set of track representations for the track 310 in the association hypotheses selected at step 720, the added track representations modelling the detected event and having at least one property based on the detected event. In particular, the added one or more track representations model the hypothesis that the detected event is occurring.

For example, for an occlusion of the object by background clutter event, the new occlusion track representation has a height and width consistent with the normal track representation prior to the occlusion of the object (e.g., the height and width of the occluded track representation remains the same as the height and width of the object before the object entered the occlusion). The location of the occluded track representation may be approximated from the unoccluded edges of the track. Accordingly, an occluded track representation is added to a track, if the object being tracked is occluded by one or more background objects, the occluded track representation predicting the location based on the unoccluded edges of the first object and the occluded track representation.

For a fragmentation/split event, new track representations may be created for N fragments. Each fragment track representation created is based on a corresponding fragment from the set of N fragments. In another arrangement, track representations may be created for only a subset M of the N fragments, for example, where M consists of the three (3) largest fragments.

At update step 860, the processor 105 updates each track representation (e.g., 350-1) in the set 320 of track representations for the track 310 in the selected association hypothesis according to the behaviour of the event that each track representation is modelling. The matched foreground areas are used as the basis for updating each track representation. In particular, the state of the “normal” track representation for the track 310 is updated by applying a set of gain values to the differences between the predicted state of the “normal” track representation and the actual state of the detected foreground areas. A gain value is a fraction between “0” and “1”, where a value of “0” causes the new state of the “normal” track representation to be the predicted state. A value of “1” causes the new state of the “normal” track representation to be the detected state of the foreground areas. The updated value for the state value X is determined in accordance with Equation (3), as follows:

X=gain_{X}(X_{detected}_{_{—}}ₛₜₐₜₑ−X_{predicted}_{_{—}}ₛₜₐₜₑ)+X_{predicted}_{_{—}}ₛₜₐₜₑ, 0≧gain_{X}≦1 (3)

where gain_{X} is the gain value for the state value X, X_{detected}_{_{—}}ₛₜₐₜₑ is the detected state for the state value X, and X_{predicted}_{_{—}}ₛₜₐₜₑ is the predicted state for the state value X.

In one arrangement, each value (e.g., height, width, x location, y location) in the state has a different gain value. In one arrangement, the gain values are determined using a Kalman filter. In another arrangement, the gain values are supplied as inputs to an Alpha Beta filter.

The occlusion track representation associated with the occlusion of the track representation is updated using a set of gain values in a similar manner to the “normal” track representation described above. However, the values (height, width, location) of the foreground areas are not directly used to update the state values of the occlusion track representation. The height and width of the occlusion track representation are kept consistent with the height and width of the normal representation prior to the occlusion of the object occurring. In another arrangement, the velocity of the foreground areas, quantised histogram of luminance, and a quantised histogram of hue of the foreground areas are kept consistent with the height and width of the normal representation prior to the occlusion of the object. The location of the occlusion track representation is determined (updated) by observing the location of the unoccluded edges of the detection, and then using the kept height and/or width of the occlusion track representation to approximate the location.

Once the occlusion track representation becomes too close to a detected occlusion, the gain values for the occlusion track representation are set to “0”. For example, the width of the foreground areas may have shrunk significantly (e.g., by half), as the object being tracked begins to be occluded by one or more background objects (“background clutter”). In this instance, the new state of the occlusion track representation is the predicted state, with the state of the foreground areas not considered. As the object being tracked begins to be occluded by one or more background objects (“background clutter”), the geometry of the foreground area may be observed to become increasingly noisy. In the methods described above, the extremely noisy foreground areas of the object as the object becomes completely occluded are prevented from polluting the state of the occlusion track representation.

A fragment track representation is updated by finding the foreground area corresponding to the fragment track representation from the combination of foreground areas in the association hypothesis selected at step 720. In one arrangement, the foreground area may be found by a simple comparison of displacement between the fragment track representations and the foreground areas. In another arrangement, the corresponding foreground area for the fragment track representation may be found by calculating a similarity measure. In another arrangement, the corresponding foreground area for the fragment track representation may be found by considering overlap of the foreground areas and the fragment track representation. Once the corresponding foreground area is found, the fragment track representation is updated in a similar method to the “normal” track representation, except the corresponding values from the corresponding selected fragment (height, width, and location) are used.

Once all the fragment track representations (e.g., 350-1) in the set 310 of track representations have been updated, in accordance with the method 800, the relative motion of the fragment track representations may be considered. If the relative motion is consistent with the fragment track representations all being part of the same object, or if there is not yet enough evidence, then the fragmentation/split event continues. If the relative motion is consistent with the fragment track representations being different objects, then a new track may be created for the fragment track representations that are the least representative of the current track. In another arrangement, a new track may be created for each fragment track representation.

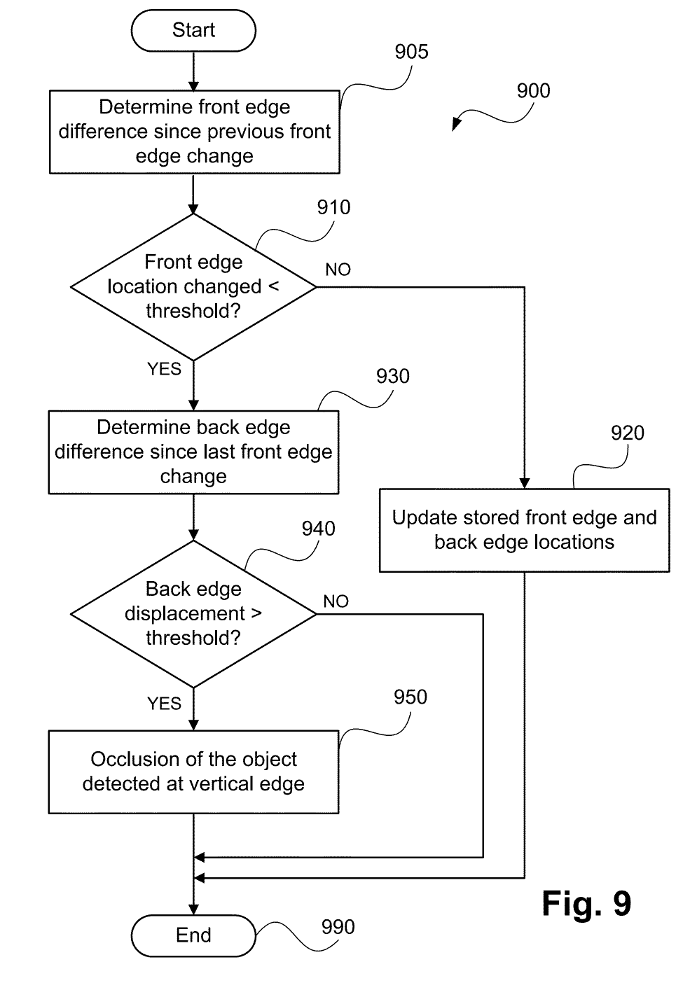

FIG. 9 is a schematic flow diagram showing a method 900 of detecting occlusion of an object within a captured image of a scene. The method 900 may be implemented as software resident within the storage module 109 of the camera 100 and being controlled in its execution by the processor 105 of the camera 100.

The method 900 detects occlusion of the object by detecting if an edge (e.g., the front edge) of a track 310 associated with the object has possibly been occluded. The method 900 determines whether the edge of the track 310 is static across observations, whilst an opposing edge (e.g., the back edge) of the track 310 is moving towards the static edge (i.e., the static front edge). In particular, if the front edge of the track 310 is relatively static and the width of the track 310 is decreasing, then an occlusion is detected at the front edge of the object associated with the track 310.

The method 900 begins at determining step 905, where the processor 105 determines a difference between a location of the front edge of the track 310 associated with the object and a previously detected location of the front edge of the track 310. The processor 105 determines the difference by comparing a value, stored within the storage device 109, representing the previously detected location of the front edge of the track 310, with the front edge of the track 310 as detected by the processor 105.

The front edge of the track 310 may be considered to be the leading edge. In particular, the front edge of the track 310 will be the left edge if the track 310 is travelling from right to left across the scene, or the front edge will be the right edge if the track 310 is travelling from the right to left to right across the scene. In another arrangement, both edges of the track 310 may be considered separately (i.e., the front edge of the track 310 need not be determined). In still another arrangement, the camera 100 may be mounted on its side such that the front edge of the track 310 is actually the top or bottom edge of the track 310. In yet another arrangement the track representations may be aligned to the contents of a scene instead of the coordinates of the camera 100, and the front edge may be a “North-West” edge, or “closer” edge.

In one arrangement, a block of data containing the front edge of the track 310 associated with the object being tracked is quantised, in order to determine the location of the front edge of the track 310. In another arrangement, the previous location of the front edge of the track 310 may be stored within the storage device 109 as a pixel location. In yet another arrangement, the previous location of the front edge of the track 310 may be a small window (i.e., a threshold may be used to determine whether the location of the front edge of the track 310 has changed).After step 905, the method 900 proceeds to decision step 910 to see if the front edge position has stopped visibly changing. If the processor 105 determines that the location of the front edge of the track 310 has not changed, by at least a threshold value (e.g., five (5) pixels), then the method 900 proceeds to step 920. Otherwise, if the front edge location has stopped then the method 900 proceeds to step 930.

At update step 920, values stored within the storage device 109, representing previously detected locations of the front edge and the back edge of the track 310, are updated to the corresponding front edge and back edge of the of the track 310 determined at step 910.

At determining step 930, the processor 105 determines the difference between location of the back edge of the track 310 and the location of the back edge value, stored within the storage device 109, representing a previously detected location of the back edge of the track 310.

Then at decision step 940, the processor 105 compares the difference determined at step 930 to a threshold (e.g., two (2) blocks, where a block may be 8×8 pixels). If the difference determined at step 930 is less than or equal to the threshold, then the method 900 terminates and no occlusion of the object being tracked by one or more background objects (“background clutter”) is detected. However, if the difference determined at step 930 is greater than the threshold, then the method 900 continues to occlusion detected step 950.

At step 950, the processor 105 indicates that an occlusion of the object being tracked by one or more background objects (“background clutter”) has been detected at the front edge of the track 310 at a corresponding location. Accordingly, the method 900 detects occlusion of the object being tracked by one or more background objects if the difference determined at step 905 is unchanged and the difference determined at step 930 is greater than the threshold.

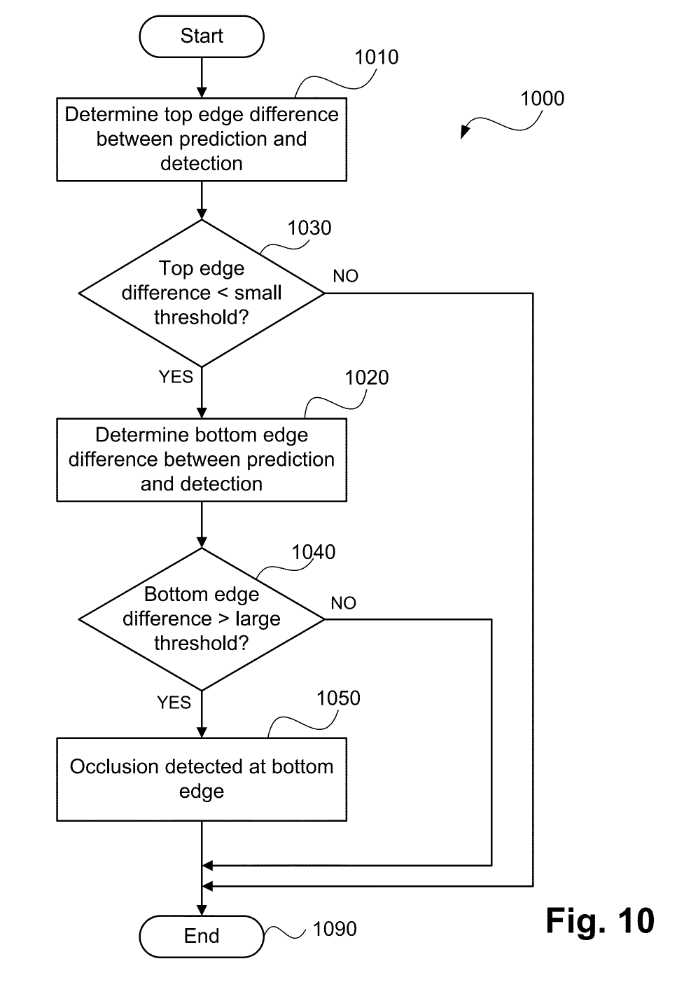

FIG. 10 is a schematic flow diagram showing a method 1000 of detecting occlusion of an object by one or more background objects (“background clutter”) within a captured image of a scene. The method 1000 may be implemented as software resident within the storage module 109 of the camera 100 and being controlled in its execution by the processor 105 of the camera 100.

The method 1000 detects an occlusion of the object by determining if the horizontal edge of a track 310 associated with the object has possibly been occluded by one or more background objects (“background clutter”). In accordance with the method 1000, the processor 105 compares values representing the prediction of a location of the top and bottom edges of a track representation (e.g., 350-1) calculated by the processor 105 in step 410 for the track representation (e.g. 350-1), to a location of the top and bottom edges of the foreground area(s) associated with the track. If one corresponding predicted edge location (e.g., the top edge location) and the location of the corresponding edge of the object are determined to be similar, and the other edge location (e.g., the bottom edge location) is determined to be dissimilar, then an occlusion of the object is detected at the top or bottom edge.

The method begins at difference determining step 1010, where the processor 105 determines a top edge difference. The top edge difference represents the difference between the prediction of the location of the top edge of the track representation (e.g., 350-1) calculated by the processor 105 at step 410, and a location of the top edge of the associated foreground area(s) determined by the processor 105. In one arrangement, the top edge difference may be measured in blocks of data. In another arrangement, the top edge difference is measured in pixels.

At decision step 1030, the processor 105 compares the top edge difference to a small threshold (e.g., two (2) blocks of data). If the processor 105 determines that the top edge difference is less than the small threshold (i.e., YES), then the method 1000 continues to difference determining step 1020. Otherwise, the method 1000 terminates with no occlusion detected.

At difference determining step 1020, the processor 105 determines a bottom edge difference. The bottom edge difference represents the difference between the prediction of the location of the bottom edge of the track representation (e.g., 350-1), calculated by the processor 105 at step 410, and the location of the bottom edge of the foreground area(s) associated with the track. Again, in one arrangement, the bottom edge difference is measured in blocks. In another arrangement, the bottom edge difference is measured in pixels.

At step 1040, the processor 105 compares the bottom edge difference to a large threshold (e.g., three (3) blocks of data). If the bottom edge difference is less than or equal to the large threshold, then no occlusion by background clutter is detected and the method 1000 concludes. If the bottom edge is greater than the large threshold (i.e., YES), then the method 1000 continues to occlusion detected step 1050.

At step 1050, the processor 105 indicates that an occlusion of the object by one or more background objects (“background clutter”) has been detected at the top edge of the track 310 associated with the object. Accordingly, the occlusion of the object being tracked, by the one or more background objects, is detected if the difference determined at step 1010 is less than the small threshold and the difference determined at step 1020 is greater than the large threshold.

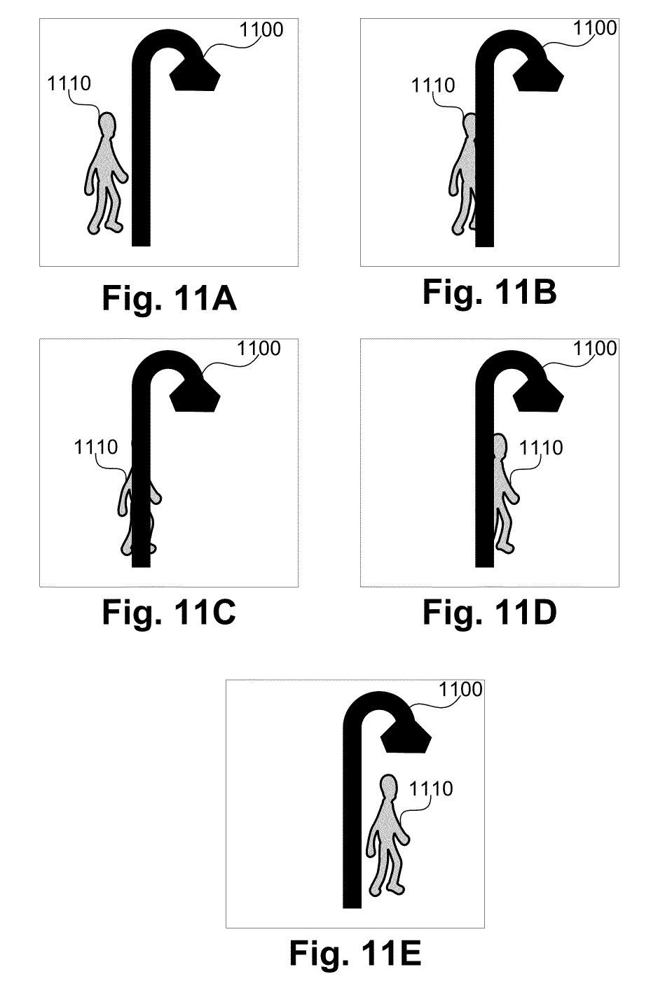

FIGS. 11A to 11E show a sequence of images that show a person 1110 passing behind a lamp post 1100. The person 1110 will be detected as foreground, and the lamp post 1100 will be background. In FIG. 11A, the person 1110 is approaching the lamp post 1100. In FIG. 11B, the person 1110 has reached the lamp post 1100, and the front of the person 1110 is being occluded by the lamp post 1100. In FIG. 11C, most of the person 1110 is occluded the lamp post 1100, and only the front and back of the person 1110 is visible. In FIG. 11D, only the rear of the person 1110 is occluded by the lamp post 1100, and the front of the person 1110 is visible. In FIG. 11E, the person 1110 is fully visible after having passed behind the lamp post 1100.

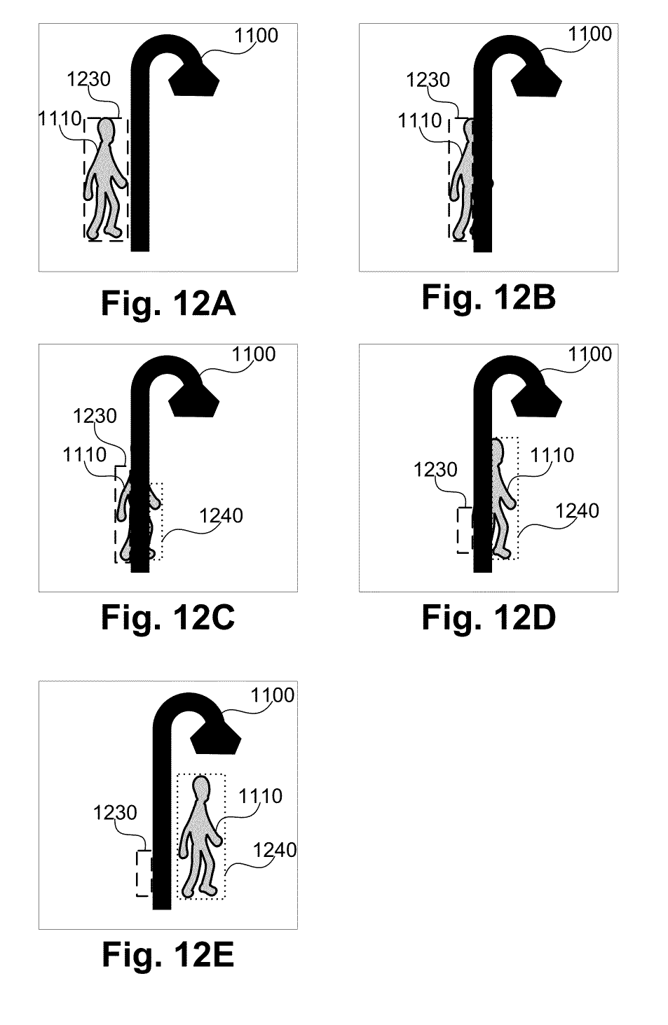

FIGS. 12A to 12E show the result of a prior art geometric tracking system attempting to track the person 1110 passing behind the lamp post 1100. In FIG. 12A, a track 1230, corresponding to the person 1110, can be seen to be tracking the person 1110. In FIG. 12B, the front of the person 1110 is occluded by the lamp post 1100, and the track 1230 can be seen to be shrinking to match the visible part of the person 1110 that is being detected as foreground. In FIG. 12C, the track 1230 is still matching the rear of the person 1110, which is still visible; however, a new track 1240 has been created for the now visible front part of the person 1110, as the front of the person 1110 emerges from behind the lamp post 1100. In FIG. 12D, the previous track 1230 can be seen to be “stuck” on the left hand side of the lamp post 1100, and is now not matching any detected foreground. The visible part of the person 1110 followed by track 1230 appeared to stop and has now gone in FIG. 12D. The new track 1240 can be seen to now be tracking the person 1110. In FIG. 12E, the previous track 1230 is still stuck on the left hand side of the lamp post 1100, and the person 1110 is now being followed by the new track 1240.

Having the track change, giving two tracks for a single foreground object, as shown in the example in FIGS. 12A to 12E, is undesirable, because the history of the foreground object (in this case, a person 1110) is lost.

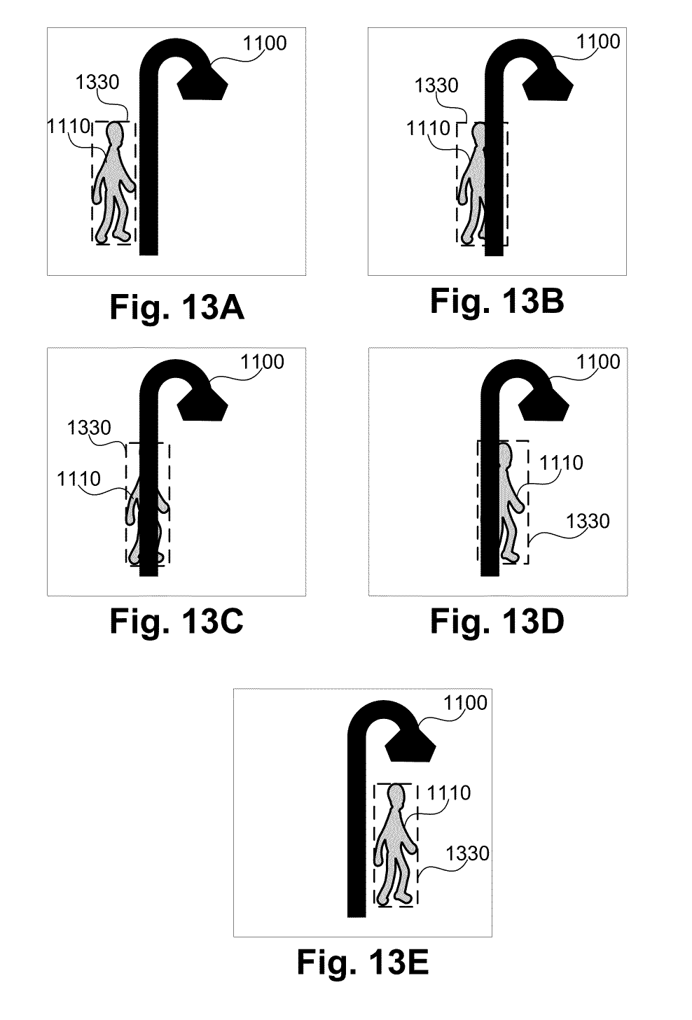

FIGS. 13A to 13E show the result of the person 1110 passing behind the lamp post 1100, and being tracked in accordance with the method 200. In FIG. 13A, the person 1110 approaches the lamp post 1100, with a track 1330 corresponding to the person. In FIG. 13B, the front of the person 1110 is occluded by the lamp post 1100, but the track 1330 is using the occlusion detection described above, so the leading edge of the track 1330 extends into the lamp post 1100. The processor 105 detects an occlusion to the person 1110 and adds a track representation which models the occlusion to the track 1330 corresponding to the person. In FIG. 13C, the middle of the person 1110 is occluded by the lamp post 1100, but both sides of the person 1110 are visible on either side of the lamp post 1100. Due to the added track representation which models the occlusion, the track 1330 is able to encompass all of the visible parts of the person 1110, and continue to follow the person 1110. In FIG. 13D, the back of the person 1110 is occluded by the lamp post 1100, and the person 1110 is still being followed by the track 1330. In FIG. 13E, the person 1110 has cleared the occluding lamp post 1100, and is still followed by the original track 1330. At FIG. 13E, the track representation which models the occlusion is deleted.

In the context of this specification, the word “comprising” means “including principally but not necessarily solely” or “having” or “including”, and not “consisting only of”. Variations of the word “comprising”, such as “comprise” and “comprises” have correspondingly varied meanings.

The foregoing describes only some embodiments of the present invention, and modifications and/or changes can be made thereto without departing from the scope and spirit of the invention, the embodiments being illustrative and not restrictive.

The claims defining the invention are as follows:

1. A method of tracking an object in a sequence of images of a scene, said method comprising:
determining an event that is affecting a foreground area corresponding to the object, the object being associated with a track having a first track representation;
adding a second track representation to the track, said second track representation being created based on the foreground area prior to the event;
updating the first track representation based on the foreground area while the second track representation is kept; and
matching at least one of the foreground areas with at least one of the first and second track representations to track the object.

2. A method according to claim 1, further comprising deleting one or more of the track representations of the track if the modelled event is false.

3. A method according to claim 1, further comprising deleting one or more of the track representations of the track if the event has ended.

4. A method according to claim 1, wherein the first track representation is an unoccluded track representation.

5. A method according to claim 4, wherein the second track representation is added as an occluded track representation to the track, if a background object is occluding said object.

6. A method according to claim 1, wherein at least one of width, height and location of the area of first track representation is updated while the width and height of the second track representation is kept.

7. A method according to claim 1, further comprising:
determining a first difference between a determined location of one edge of a track associated with the object and a previously determined location of the corresponding edge of the track,
determining a second difference between the determined location of a further edge of the track and a previously determined location of the corresponding further edge of the track; and
detecting occlusion of the object as the event if the first difference is less than a threshold and the second difference is greater than a threshold.

8. A method according to claim 1, further comprising:
determining a first difference between an edge of a prediction of a track corresponding to the object and the corresponding edge of a foreground area of the scene associated with the track;
determining a second difference between a further edge of the prediction of the track corresponding to the object and the corresponding further edge of the foreground area of the scene associated with the track; and
detecting an occlusion of the object as the event if the first difference is less than a first threshold and the second difference is greater than a second threshold.

9. An apparatus for tracking an object in a sequence of images of a scene, said apparatus comprising:
means for determining an event that is affecting the foreground area corresponding to the object, the object being associated with a track having a first track representation;
means for adding a second track representation to the track, said second track representation being created based on the foreground area of the object prior to the event; and
means for updating the first track representation, based on the foreground area of the object while the second track representation is kept; and
means for matching at least one of the foreground areas with at least one of the first and second track representations to track the object.

10. A non-transitory computer readable medium having a computer program stored there for tracking an object in a sequence of images of a scene, said program comprising:
code for determining an event that is affecting a foreground area corresponding to the object, the object being associated with a track having a first track representation;
code for adding a second track representation to the track, said second track representation being created based on the foreground area prior to the event;
code for updating the first track representation based on the foreground area while the second track representation is kept; and
code for matching at least one of the foreground areas with at least one of the first and second track representations to track the object.

11. A method of detecting occlusion of an object within a captured image of a scene, said method comprising:
determining a first difference between an edge of a prediction of a track corresponding to the object and the corresponding edge of a foreground area of the scene associated with the track;
determining a second difference between a further edge of the prediction of the track corresponding to the object and the corresponding further edge of the foreground area of the scene associated with the track; and
detecting an occlusion of the object if the first difference is less than a first threshold and the second difference is greater than a second threshold.

12. An apparatus for detecting occlusion of an object within a captured image of a scene, said apparatus comprising:
means for determining a first difference between an edge of a prediction of a track corresponding to the object and the corresponding edge of a foreground area of the scene associated with the track;
means for determining a second difference between a further edge of the prediction of the track corresponding to the object and the corresponding further edge of the foreground area of the scene associated with the track; and
means for detecting an occlusion of the object if the first difference is less than a first threshold and the second difference is greater than a second threshold.

13. A non-transitory computer readable medium having a computer program stored thereon for detecting occlusion of an object within a captured image of a scene, said program comprising:
code for determining a first difference between an edge of a prediction of a track corresponding to the object and the corresponding edge of a foreground area of the scene associated with the track;
code for determining a second difference between a further edge of the prediction of the track corresponding to the object and the corresponding further edge of the foreground area of the scene associated with the track; and
code for detecting an occlusion of the object if the first difference is less than a first threshold and the second difference is greater than a second threshold.
